(19) United States
(12) Patent Application Publication
(10) Pub. No.: US 2026/0018744 A1
(43) Pub. Date: Jan. 15, 2026

(54) BUS BAR MODULE

(71) Applicant: YAZAKI CORPORATION, Tokyo (JP)

(72) Inventors: Hirotaka Hasegawa, Kakegawa-shi (JP); Ryosuke Murata, Fujieda-shi (JP)

(21) Appl. No.: 19/332,034

(22) Filed: Sep. 17, 2025

Related U.S. Application Data
(63) Continuation of application No. PCT/JP2024/005713, filed on Feb. 19, 2024.

(30) Foreign Application Priority Data
Mar. 20, 2023 (JP) 2023-043750

(51) Int. Cl. H01M 50/503; H01M 50/209; H01M 50/507; H01M 50/517; H01M 50/569; H01M 50/588

(52) U.S. Cl. CPC H01M 50/503; H01M 50/507; H01M 50/517; H01M 50/569; H01M 50/588; H01M 50/209

(57) ABSTRACT

A second bus bar of a bus bar module includes a first electrical connection part connected to one electrode terminal, a second electrical connection part connected to another electrode terminal, and a U-shaped bypass part that connects the first and the second electrical connection parts and bypasses a projection on a battery module. A housing case includes a first bus bar housing part that houses a first bus bar, a second bus bar housing part that houses the first electrical connection part, a third bus bar housing part that houses the second electrical connection part, and an electric wire housing part that guides an electric wire along a bottom wall that is disposed to be opposed to the battery module. The electric wire housing part is disposed adjacent to the first bus bar housing part, the second bus bar housing part, and the third bus bar housing part.

### CROSS-REFERENCE TO RELATED APPLICATION

This application is a continuation application of International Application No. PCT/JP2024/005713 filed on Feb. 19, 2024 which claims the benefit of priority from Japanese Patent Application No. 2023-043750 filed on Mar. 20, 2023 and designating the U.S., the entire contents of which are incorporated herein by reference.

### BACKGROUND OF THE INVENTION

### 1. Field of the Invention

The present invention relates to a bus bar module.

### 2. Description of the Related Art

Conventionally, a bus bar module includes a bus bar that physically and electrically connects electrode terminals of adjacent battery cells. Such a type of bus bar module is disclosed in Japanese Patent Application Laid-open No. JP 2012-243 689, Japanese Patent Application Laid-open No. JP 2015-133 223, and Japanese Patent Application Laid-open No. JP 2021-002 524, for example. Each bus bar module disclosed in Japanese Patent Application Laid-open No. JP 2015-133 223, and Japanese Patent Application Laid-open No. JP 2021-002 524 includes an electric wire with a terminal that is physically and electrically connected to the bus bar and electrically connects the bus bar with a battery monitoring unit (a monitoring device that monitors a battery state of a battery cell). Japanese Patent Application Laid-open No. JP 2012-243 689 discloses a technique of coping with misalignment between electrode terminals of adjacent battery cells by forming a notch or a slit on the bus bar to cause the bus bar to easily bend.

In a battery module in which a plurality of battery cells are arranged, for example, various structures such as a partition wall between adjacent battery cells and an exhaust duct are provided, and part of the structure or the structure itself is exposed as a projection in some cases. Thus, in the bus bar module, in a case in which the projection is present between electrode terminals, the electrode terminals need to be connected to each other by a bus bar avoiding the projection. In this case, it is necessary to avoid interference with an electric wire with a terminal on a bypass route of the bus bar.

### SUMMARY OF THE INVENTION

The present invention aims at providing a bus bar module that is preferable for bypassing a projection.

In order to solve the above mentioned problems and achieve the object, a bus bar module according to one aspect of the present invention includes a bus bar that is a conductive member physically and electrically connected to each of electrode terminals of a plurality of battery cells arranged in a line in a battery module, and connects a pair of electrode terminals for each combination of the electrode terminals that are adjacent to each other with a space therebetween in an arrangement direction of the battery cells; an electric wire with a terminal that includes a terminal fitting physically and electrically connected to the bus bar on one terminal of the electric wire, and electrically connects another terminal side of the electric wire to a battery monitoring unit that monitors a battery state of the battery cell; and an insulating housing case that houses the bus bar and the electric wire with the terminal, wherein a plurality of the bus bars are broadly divided into a first bus bar extended in the arrangement direction to connect the pair of electrode terminals, and a second bus bar that is caused to bypass a projection in the space included in the battery module in a U-shape on the battery module to connect the pair of electrode terminals while avoiding the projection, the second bus bar includes a first electrical connection part having a flat plate shape that is physically and electrically connected to one of the pair of electrode terminals, a second electrical connection part having a flat plate shape that is physically and electrically connected to another of the pair of electrode terminals, and a U-shaped bypass part that connects the first electrical connection part with the second electrical connection part and bypasses the projection on the battery module, the housing case includes a first bus bar housing part that houses the first bus bar, a second bus bar housing part that houses the first electrical connection part of the second bus bar, a third bus bar housing part that houses the second electrical connection part of the second bus bar, and an electric wire housing part that houses the electric wire and guides the electric wire toward the battery monitoring unit side along a bottom wall disposed to be opposed to the battery module, the electric wire housing part is disposed to be adjacent to the first bus bar housing part, the second bus bar housing part, and the third bus bar housing part in a direction orthogonal to the arrangement direction and a direction orthogonal to planes of the first electrical connection part and the second electrical connection part, and is extended in the arrangement direction, the electric wire is routed in the arrangement direction along one wall surface of the bottom wall, and the second bus bar is disposed on another wall surface side of the bottom wall.

In order to solve the above mentioned problems and achieve the object, a bus bar module according to another aspect of the present invention includes a bus bar that is a conductive member physically and electrically connected to each of electrode terminals of a plurality of battery cells arranged in a line in a battery module, and connects a pair of electrode terminals for each combination of the electrode terminals that are adjacent to each other with a space therebetween in an arrangement direction of the battery cells; an electric wire with a terminal that includes a terminal fitting physically and electrically connected to the bus bar on one terminal of the electric wire, and electrically connects another terminal side of the electric wire to a battery monitoring unit that monitors a battery state of the battery cell; and an insulating housing case that houses the bus bar and the electric wire with the terminal, wherein a plurality of the bus bars are broadly divided into a first bus bar extended in the arrangement direction to connect the pair of electrode terminals, and a second bus bar that is caused to bypass a projection in the space included in the battery module in a U-shape on the battery module to connect the pair of electrode terminals while avoiding the projection, the second bus bar includes a first electrical connection part having a flat plate shape that is physically and electrically connected to one of the pair of electrode terminals, a second electrical connection part having a flat plate shape that is physically and electrically connected to another of the pair of electrode terminals, and a U-shaped bypass part that connects the first electrical connection part with the second electrical connection part and bypasses the projection on the battery module, and the second bus bar is formed in an asymmetrical shape on a first direction side as one side of the arrangement direction and a second direction side as the other side of the arrangement direction, the housing case includes a first bus bar housing part that houses the first bus bar, a second bus bar housing part that houses the first electrical connection part of the second bus bar, a third bus bar housing part that houses the second electrical connection part of the second bus bar, an electric wire housing part that houses the electric wire and guides the electric wire toward the battery monitoring unit side along a bottom wall disposed to be opposed to the battery module, a first electric wire lead-out path that allows the electric wire of the electric wire with the terminal having the terminal fitting physically and electrically connected to the first electrical connection part to be drawn into the electric wire housing part while being tilted toward the first direction side of the arrangement direction, and a second electric wire lead-out path that allows the electric wire of the electric wire with the terminal having the terminal fitting physically and electrically connected to the second electrical connection part to be drawn into the electric wire housing part while being tilted toward the first direction side of the arrangement direction, the electric wire housing part is disposed to be adjacent to the first bus bar housing part, the second bus bar housing part, and the third bus bar housing part in a direction orthogonal to the arrangement direction and a direction orthogonal to a plane of the second bus bar, and is extended in the arrangement direction, the first electric wire lead-out path is coupled to an end part on the first direction side of the second bus bar housing part, and the bypass part is projected from an end part on the second direction side to the outside, and the second electric wire lead-out path is coupled to an end part on the first direction side of the third bus bar housing part, and the bypass part is projected from an end part on the second direction side to the outside.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a bus bar module in an embodiment assembled to a battery module;

FIG. 2 is a perspective view illustrating the bus bar module in the embodiment before being assembled to the battery module;

FIG. 3 is a plan view of the bus bar module in the embodiment assembled to the battery module viewed from a front side;

FIG. 4 is a plan view of the bus bar module in the embodiment viewed from a back side;

FIG. 5 is a perspective view illustrating a first bus bar;

FIG. 6 is a perspective view illustrating a second bus bar;

FIG. 7 is a perspective view illustrating an electric wire with a terminal;

FIG. 8 is a perspective view of a housing case viewed from the front side;

FIG. 9 is a plan view of the housing case viewed from the front side;

FIG. 10 is a perspective view of the housing case viewed from the back side; and

FIG. 11 is a plan view of the housing case viewed from the back side.

### DETAILED DESCRIPTION OF THE PREFERRED EMBODIMENTS

The following describes an embodiment of a bus bar module according to the present invention in detail based on the drawings. The present invention is not limited to the embodiment.

### Embodiment

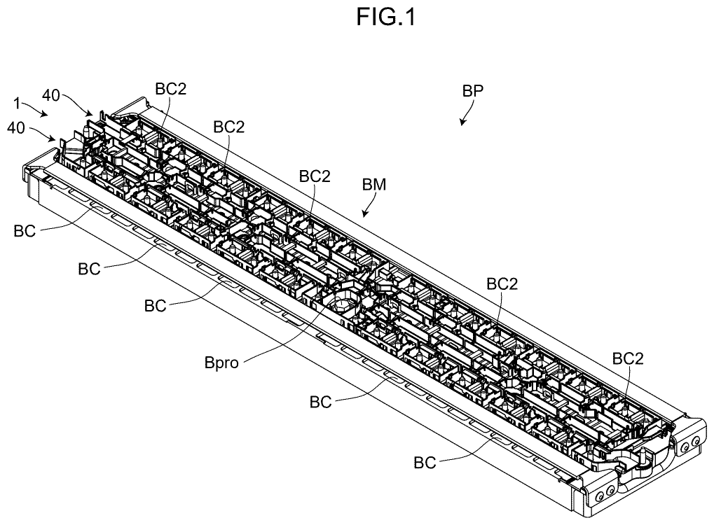

The following describes one embodiment of a bus bar module according to the present invention based on FIG. 1 to FIG. 11.

Reference numeral 1 in FIG. 1 to FIG. 4 denotes the bus bar module in the present embodiment. The bus bar module 1 configures a battery pack BP together with a battery module BM by being assembled to the battery module BM in which a plurality of battery cells BC are arranged in a line (FIG. 1 to FIG. 3). The battery pack BP is, for example, mounted on a vehicle (an electric vehicle, a hybrid vehicle, and the like) including a rotary machine as a driving source, and used for supplying power to the rotary machine, for example.

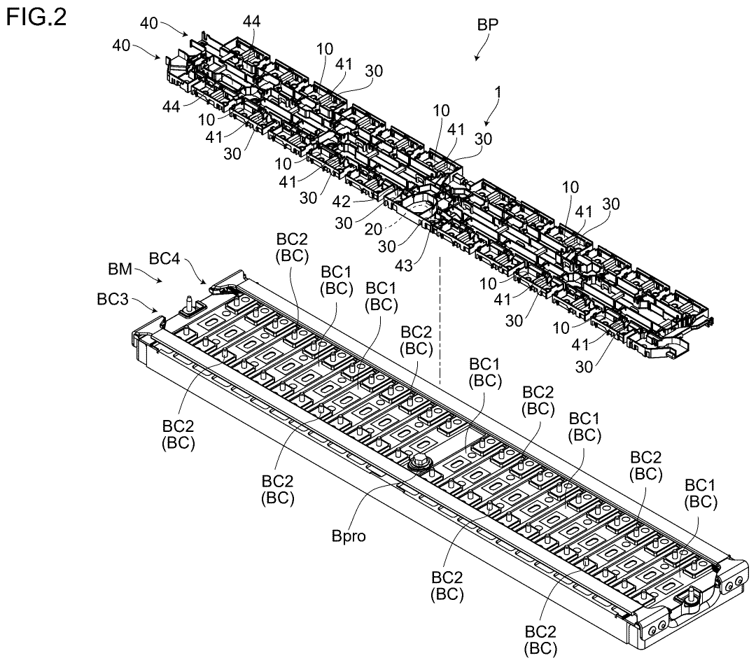

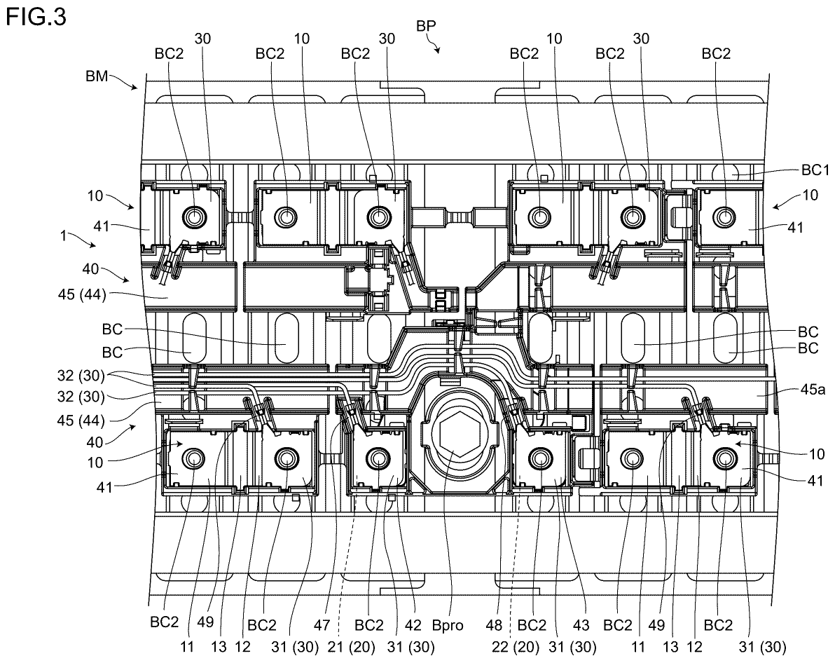

The battery cell BC includes a cell body BC1, and positive and negative electrode terminals BC2 (FIG. 2 and FIG. 3). The battery cell BC described herein is formed in a rectangular solid shape in which the cell body BC1 has six outer wall surfaces, and the positive and negative electrode terminals BC2 are disposed at an interval on one of the six outer wall surfaces of the cell body BC1. The battery module BM includes a first electrode terminal group BC3 in which the electrode terminals BC2 on one side of the respective battery cells BC are arranged in a line in an arrangement direction of the battery cells BC, and a second electrode terminal group BC4 in which the electrode terminals BC2 on the other side of the respective battery cells BC are arranged in a line in the arrangement direction (FIG. 2).

The electrode terminal BC2 may be an electrode terminal having a plate shape or a rectangular solid shape disposed on the outer wall surface of the cell body BC1, or may be an electrode pole having a pillar shape projected from the outer wall surface of the cell body BC1. In a case of the electrode terminal BC2 having a plate shape or a rectangular solid shape, a bus bar (described later) is physically and electrically connected to the electrode terminal BC2 by welding and the like. In a case of the electrode terminal BC2 serving as the electrode pole, a male screw part is disposed on the electrode terminal BC2, so that the electrode terminal BC2 is inserted through a through hole of the bus bar (described later), and a female screw member is screwed on the male screw part of the electrode terminal BC2 to physically and electrically connect the bus bar to the electrode terminal BC2. Herein, the electrode terminal BC2 serving as the electrode pole is exemplified.

The bus bar module 1 is a conductive member to be physically and electrically connected to the electrode terminals BC2 of the battery cells BC, and includes the bus bar that connects a pair of the electrode terminals BC2 for each combination of the electrode terminals BC2 that are adjacent to each other with a space therebetween in the arrangement direction of the battery cells BC. A plurality of the bus bars are broadly divided into a first bus bar 10 extended in the arrangement direction of the battery cells BC to connect the pair of electrode terminals BC2, and a second bus bar 20 that is caused to bypass a projection Bpro in the above-described space included in the battery module BM in a U-shape on the battery module BM to connect the pair of electrode terminals BC2 while avoiding the projection Bpro (FIG. 2 to FIG. 4). Hereinafter, the pair of electrode terminals BC2 is described unless specifically noted, the pair of electrode terminals BC2 mean two electrode terminals BC2 that are adjacent to each other with a space therebetween in the arrangement direction of the battery cells BC.

The bus bar (the first bus bar 10, the second bus bar 20) described herein is a plate-shaped conductive member made of metal, and formed by press forming using a metal plate made of copper, a copper alloy, or the like as a base material, for example.

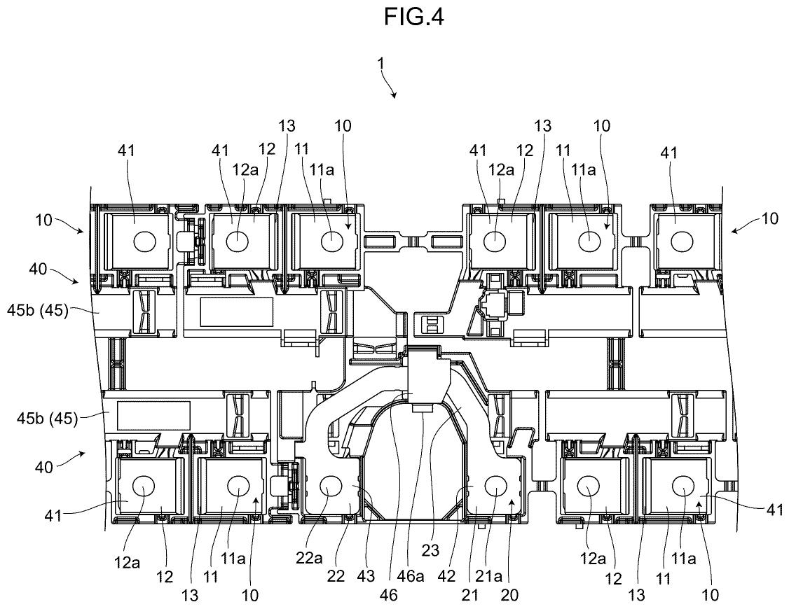

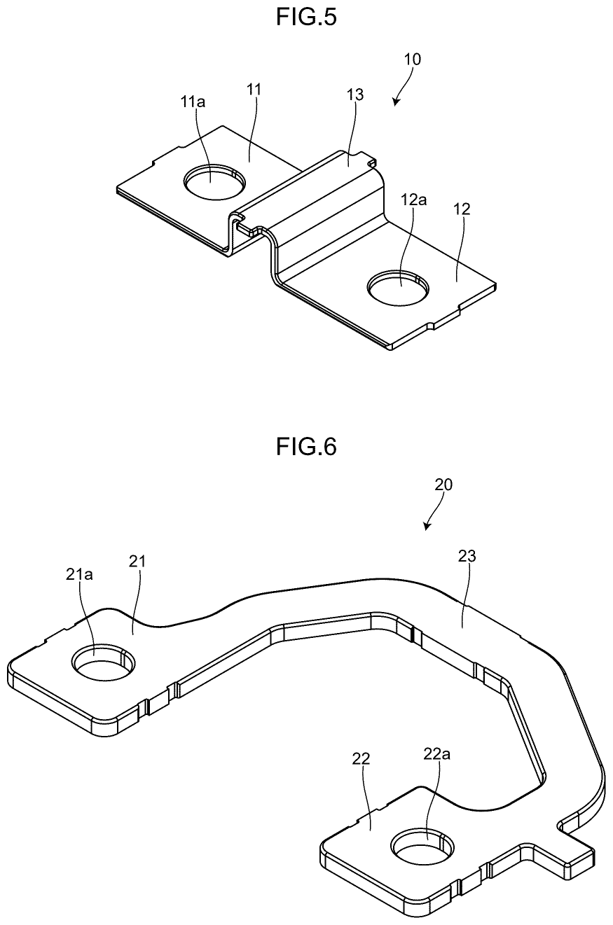

The first bus bar 10 is formed in a plate shape having a plate width in a direction orthogonal to the arrangement direction of the battery cells BC. The first bus bar 10 includes a first electrical connection part 11 having a flat plate shape that is physically and electrically connected to one of the pair of electrode terminals BC2, and a second electrical connection part 12 having a flat plate shape that is physically and electrically connected to the other one thereof (FIG. 3 to FIG. 5). The first electrical connection part 11 and the second electrical connection part 12 are formed in a rectangular flat plate shape. Through holes 11a and 12a through which the electrode terminals BC2 as electrode poles are inserted are formed on the first electrical connection part 11 and the second electrical connection part 12 (FIG. 4 and FIG. 5).

The first bus bar 10 includes a coupling part 13 that connects the first electrical connection part 11 with the second electrical connection part 12 in the arrangement direction of the battery cells BC (FIG. 3 to FIG. 5). The coupling part 13 is disposed in a space between one of the pair of electrode terminals BC2 and the other one thereof in the arrangement direction.

The first electrical connection part 11, the second electrical connection part 12, and the coupling part 13 are formed in a plate shape so that plate widths thereof are uniform and plate thicknesses thereof are uniform. That is, in the first bus bar 10, cross-sectional areas of cross sections orthogonal to the arrangement direction of the battery cells BC are equal to each other among the first electrical connection part 11, the second electrical connection part 12, and the coupling part 13.

In the battery module BM, for example, when thermal expansion or thermal contraction is caused in the battery cell BC accompanying traveling of a vehicle and the like, an interval between one of the pair of electrode terminals BC2 and the other one thereof (hereinafter, referred to as an “inter-electrode pitch”) varies in the arrangement direction of the battery cells BC. The coupling part 13 is formed to be able to be distorted or deformed in the arrangement direction to cause the first bus bar 10 to follow the variation of the inter-electrode pitch. For example, the coupling part 13 is formed in a projecting chevron shape that can be distorted or deformed. The exemplified coupling part 13 includes erected wall parts each having a rectangular flat plate shape that are respectively projected from respective end sides of the first electrical connection part 11 and the second electrical connection part 12 opposed to each other in the arrangement direction of the battery cells BC, and a top part having a rectangular flat plate shape that couples end sides on a projecting direction side of the respective erected wall parts.

The second bus bar 20 includes a first electrical connection part 21 having a flat plate shape that is physically and electrically connected to one of the pair of electrode terminals BC2, and a second electrical connection part 22 having a flat plate shape that is physically and electrically connected to the other one thereof (FIG. 3, FIG. 4, and FIG. 6). The first electrical connection part 21 and the second electrical connection part 22 are formed in a rectangular flat plate shape. Through holes 21a and 22a through which the electrode terminals BC2 as electrode poles are inserted are formed on the first electrical connection part 21 and the second electrical connection part 22 (FIG. 4 and FIG. 6).

In the battery module BM, the projection Bpro may be disposed in a space between one of the pair of electrode terminals BC2 and the other one thereof. The projection Bpro is part of a structure (for example, a partition wall between adjacent battery cells BC, an exhaust duct, or the like) included in the battery module BM, or a structure itself included in the battery module BM. In this example, a head part of a male screw member is present as the projection Bpro in the space between the two electrode terminals BC2. In a case in which the projection Bpro as described above is present, when the pair of electrode terminals BC2 are attempted to be connected with each other by the first bus bar 10, the coupling part 13 of the first bus bar 10 interferes with the projection Bpro. Thus, in this case, the first bus bar 10 cannot be applied as a bus bar for electrically connecting the pair of electrode terminals BC2. Accordingly, in the bus bar module 1, the second bus bar 20 adapted to the projection Bpro is used.

The second bus bar 20 includes a U-shaped bypass part 23 that connects the first electrical connection part 21 with the second electrical connection part 22, and bypasses the projection Bpro on the battery module BM (FIG. 4 and FIG. 6). For example, in a case of applying the second bus bar 20 to the pair of electrode terminals BC2 in the first electrode terminal group BC3, the bypass part 23 is projected from the first electrical connection part 21 and the second electrical connection part 22 toward the second electrode terminal group BC4 side. For example, in a case of applying the second bus bar 20 to the pair of electrode terminals BC2 of the second electrode terminal group BC4, the bypass part 23 is projected from the first electrical connection part 21 and the second electrical connection part 22 toward the first electrode terminal group BC3 side.

In the second bus bar 20, the bypass part 23 is formed to be able to be distorted or deformed in the arrangement direction of the battery cells BC to follow the variation of the inter-electrode pitch described above. For example, the bypass part 23 can be distorted or deformed by being formed in a shape described below. First, in the second bus bar 20 described herein, the bypass part 23 is formed on the same plane as the first electrical connection part 21 and the second electrical connection part 22. That is, the exemplified second bus bar 20 is formed in a flat plate shape having the first electrical connection part 21, the second electrical connection part 22, and the bypass part 23 on the same plane. Next, in the second bus bar 20, a plate width of the bypass part 23 (plate width in a direction orthogonal to a center axis on the bypass route connecting the first electrical connection part 21 with the second electrical connection part 22) is made narrower than an interval between opposite sides of each of the first electrical connection part 21 and the second electrical connection part 22 (opposite sides in a direction orthogonal to the arrangement direction of the battery cells BC and a direction orthogonal to the plane of the second bus bar 20). Due to this, in the second bus bar 20, the bypass part 23 absorbs, by being distorted and deformed, force applied to the first electrical connection part 21 and the second electrical connection part 22 due to variation of the inter-electrode pitch while following the variation of the inter-electrode pitch.

On the other hand, in the second bus bar 20, by making the plate width of the bypass part 23 narrower than the interval between the opposite sides of each of the first electrical connection part 21 and the second electrical connection part 22, electrical resistance values may differ among respective positions of the first electrical connection part 21, the second electrical connection part 22, and the bypass part 23. Thus, in the second bus bar 20, the first electrical connection part 21, the second electrical connection part 22, and the bypass part 23 are formed in the following shape (not illustrated) to suppress differences in the electrical resistance values to be small among the positions of the first electrical connection part 21, the second electrical connection part 22, and the bypass part 23. First, in the first electrical connection part 21 and the second electrical connection part 22, the interval between the opposite sides in the direction orthogonal to the arrangement direction of the battery cells BC and the direction orthogonal to the plane of the second bus bar 20 is the same and the plate thickness is the same, and cross-sectional areas of cross sections orthogonal to the arrangement direction are formed in the same rectangular flat plate shape (excluding a portion where the through hole is present). Next, the bypass part 23 is formed in a flat plate shape by making the plate width in the direction orthogonal to the center axis on the bypass route connecting the first electrical connection part 21 with the second electrical connection part 22 narrower than the interval between the opposite sides of each of the first electrical connection part 21 and the second electrical connection part 22 (opposite sides in the direction orthogonal to the arrangement direction of the battery cells BC and the direction orthogonal to the plane of the second bus bar 20), making the plate thickness thicker than the plate thicknesses of the first electrical connection part 21 and the second electrical connection part 22, and causing a cross-sectional area of a cross section orthogonal to the center axis to have the same size as the cross-sectional areas of the first electrical connection part 21 and the second electrical connection part 22. The plate width and the plate thickness of the bypass part 23 are set to be able to be distorted or deformed for following variation of the inter-electrode pitch. Due to this, the second bus bar 20 can follow variation of the inter-electrode pitch while suppressing a difference in the electrical resistance value to be small.

For example, the cross-sectional areas of the first electrical connection part 21, the second electrical connection part 22, and the bypass part 23 are caused to be the same size as the cross-sectional area of the cross section orthogonal to the arrangement direction in the first bus bar 10. Due to this, the bus bar module 1 can suppress a difference in energization performance between the first bus bar 10 and the second bus bar 20.

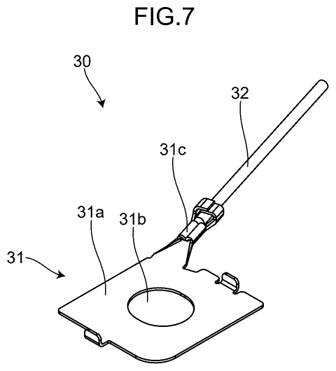

The bus bar module 1 includes an electric wire 30 with a terminal including a terminal fitting 31 physically and electrically connected to the bus bar (the first bus bar 10, the second bus bar 20) on one terminal of an electric wire 32 in which another terminal side of the electric wire 32 is electrically connected to a battery monitoring unit that monitors a battery state (a voltage, a current, a temperature, and the like) of the battery cell BC (FIG. 2, FIG. 3, and FIG. 7).

The bus bar module 1 includes an electric wire with the terminal 30 for each first bus bar 10 that is physically and electrically connected to the first bus bar 10, the electric wire with the terminal 30 that is physically and electrically connected to the first electrical connection part 21 of the second bus bar 20, and the electric wire with the terminal 30 that is physically and electrically connected to the second electrical connection part 22 of the second bus bar 20. The same electric wires 30 with the terminals may be applied to all first bus bars 10 and the second bus bar 20, or different electric wires 30 with the terminals may be appropriately used for the first bus bar 10 and the second bus bar 20 depending on a routing path of the electric wire 32 (described later). However, in this example, the electric wire with the terminal 30 physically and electrically connected to the first electrical connection part 21 of the second bus bar 20 and the electric wire with the terminal 30 physically and electrically connected to the second electrical connection part 22 of the second bus bar 20 are the same.

The terminal fitting 31 includes a terminal connection part 31a having a flat plate shape that can be arranged to be stacked on the first electrical connection part 11 or 21, or the second electrical connection part 12 or 22, and is fastened together with the first electrical connection part 11 or 21, or the second electrical connection part 12 or 22 by the female screw member screwed on the electrode terminal BC2 having the male screw part (FIG. 7). The terminal connection part 31a is formed in a rectangular flat plate shape. The terminal connection part 31a is stacked on the first electrical connection part 11 or 21, or the second electrical connection part 12 or 22 while causing one of opposite sides at two positions to run along the arrangement direction of the battery cells BC. A through hole 31b through which the electrode terminal BC2 as the electrode pole is inserted is formed on the terminal connection part 31a.

The terminal fitting 31 also includes an electric wire connection part 31c physically and electrically connected to one terminal of the electric wire 32 (FIG. 7). The exemplified electric wire connection part 31c is formed as a crimping part that crimps a pair of barrel pieces onto an exposed core wire of one terminal of the electric wire 32.

The electric wire connection part 31c is projected from one of four corners of the terminal connection part 31a. For example, in a case of applying the electric wire with the terminal 30 to the electrode terminal BC2 of the first electrode terminal group BC3, the electric wire connection part 31c is projected from one of the four corners of the terminal connection part 31a toward the second electrode terminal group BC4 side. For example, in a case of applying the electric wire with the terminal 30 to the electrode terminal BC2 of the second electrode terminal group BC4, the electric wire connection part 31c is projected from one of the four corners of the terminal connection part 31a toward the first electrode terminal group BC3 side.

The electric wire connection part 31c described herein is projected from one of the four corners of the terminal connection part 31a on the same plane as the terminal connection part 31a while being tilted in each of opposite directions of two pairs of opposite sides of the terminal connection part 31a. In a case of routing the electric wire 32 drawn out from the electric wire connection part 31c toward the first direction side, which is one side of the arrangement direction of the battery cells BC, the electric wire connection part 31c is projected in a state of being tilted toward the first direction side. In a case of routing the electric wire 32 drawn out from the electric wire connection part 31c toward the second direction side, which is the other side of the arrangement direction of the battery cells BC, the electric wire connection part 31c is projected in a state of being tilted toward the second direction side.

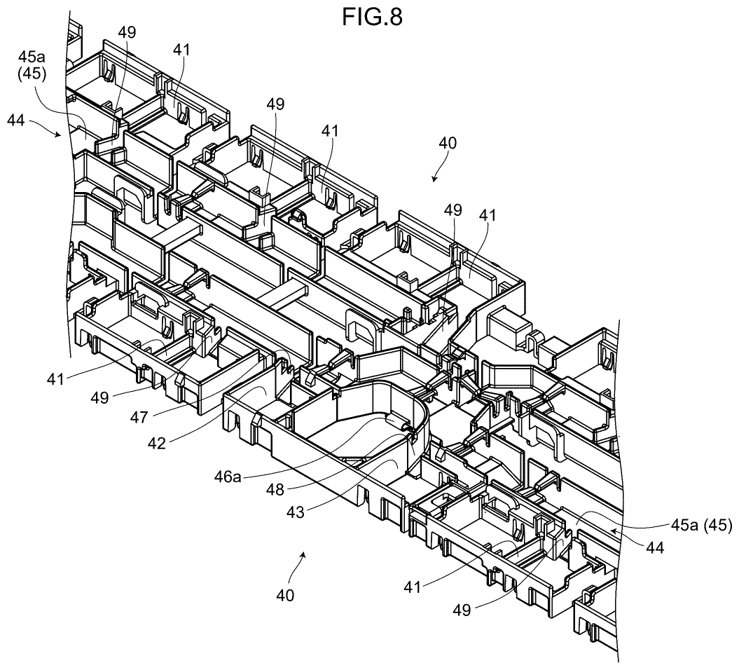

The bus bar module 1 includes an insulating housing case 40 that houses the bus bars (the first bus bar 10, the second bus bar 20), and the electric wires 30 with the terminals (FIG. 1 to FIG. 4, and FIG. 8 to FIG. 11). The housing case 40 is made of an insulating material such as synthetic resin. In the bus bar module 1, housing cases 40 are respectively disposed on the first electrode terminal group BC3 side and the second electrode terminal group BC4 side.

The housing case 40 includes a first bus bar housing part 41 that houses the first bus bar 10, a second bus bar housing part 42 that houses the first electrical connection part 21 of the second bus bar 20, and a third bus bar housing part 43 that houses the second electrical connection part 22 of the second bus bar 20 (FIG. 2 to FIG. 4, and FIG. 8 to FIG. 11).

The first bus bar 10 is housed in the first bus bar housing part 41, and assembled to the pair of electrode terminals BC2 in the first bus bar housing part 41. The electric wire with the terminal 30 stacks the terminal connection part 31a of the terminal fitting 31 on the first electrical connection part 11 or the second electrical connection part 12 of the first bus bar 10 in the first bus bar housing part 41.

The first electrical connection part 21 of the second bus bar 20 is housed in the second bus bar housing part 42, and assembled to one of the pair of electrode terminals BC2 in the second bus bar housing part 42. The electric wire with the terminal 30 stacks the terminal connection part 31a of the terminal fitting 31 on the first electrical connection part 21 of the second bus bar 20 in the second bus bar housing part 42. The second electrical connection part 22 of the second bus bar 20 is housed in the third bus bar housing part 43, and assembled to the other of the pair of electrode terminals BC2 in the third bus bar housing part 43. The electric wire with the terminal 30 stacks the terminal connection part 31a of the terminal fitting 31 on the second electrical connection part 22 of the second bus bar 20 in the third bus bar housing part 43.

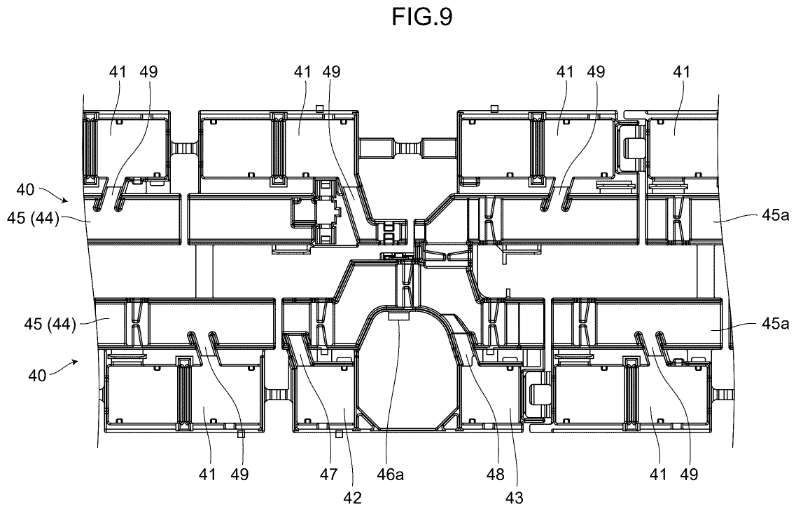

Furthermore, the housing case 40 includes an electric wire housing part 44 that houses the electric wire 32 of the electric wire with the terminal 30 (FIG. 2, FIG. 3, FIG. 8, and FIG. 9). In a case of the housing case 40 on the first electrode terminal group BC3 side, the electric wire housing part 44 houses electric wires 32 of all of the electric wires 30 with the terminals physically and electrically connected to the electrode terminals BC2 of the first electrode terminal group BC3. In a case of the housing case 40 on the second electrode terminal group BC4 side, the electric wire housing part 44 houses the electric wires 32 of all of the electric wires 30 with the terminals physically and electrically connected to the electrode terminals BC2 of the second electrode terminal group BC4.

Herein, in this example, the projection Bpro is present only on the first electrode terminal group BC3 side. Due to this, the electric wire housing part 44 of the housing case 40 on the first electrode terminal group BC3 side bypasses the projection Bpro in a U-shape on the battery module BM.

The electric wire housing part 44 includes a bottom wall 45 arranged to be opposed to the battery module BM, and guides the electric wire 32 along the bottom wall 45 to the battery monitoring unit side (FIG. 3, FIG. 4, and FIG. 8 to FIG. 11). The electric wire housing part 44 is disposed to be adjacent to the first bus bar housing part 41, the second bus bar housing part 42, and the third bus bar housing part 43 in the direction orthogonal to the arrangement direction of the battery cells BC and the direction orthogonal to the planes of the first electrical connection parts 11 and 21 and the second electrical connection parts 12 and 22, and extended in the arrangement direction. In a case of the housing case 40 on the first electrode terminal group BC3 side, the electric wire housing part 44 is disposed to be adjacent to the first bus bar housing part 41, the second bus bar housing part 42, and the third bus bar housing part 43 on the second electrode terminal group BC4 side. In a case of the housing case 40 on the second electrode terminal group BC4 side, the electric wire housing part 44 is disposed to be adjacent to the first bus bar housing part 41, the second bus bar housing part 42, and the third bus bar housing part 43 on the first electrode terminal group BC3 side.

In the bus bar module 1, the bypass part 23 of the second bus bar 20 is present at the position of the electric wire housing part 44. Thus, the bus bar module 1 is configured as follows to prevent interference between the bypass part 23 and the electric wire 32 in the electric wire housing part 44.

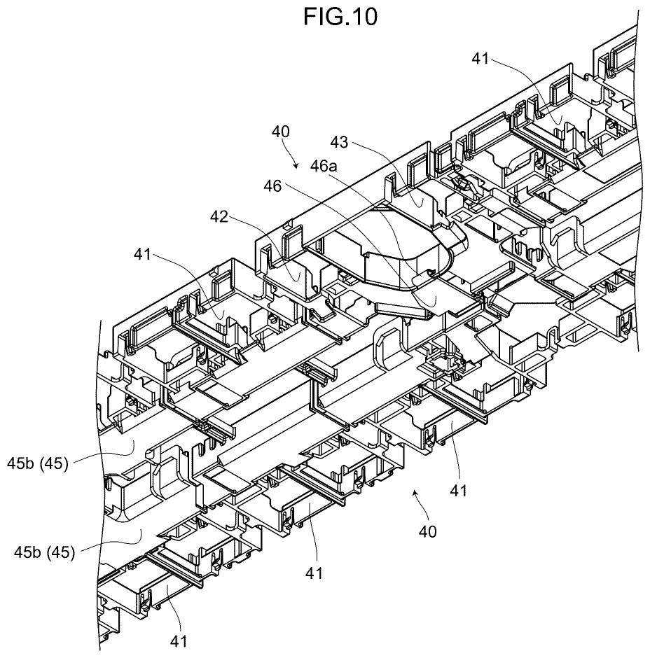

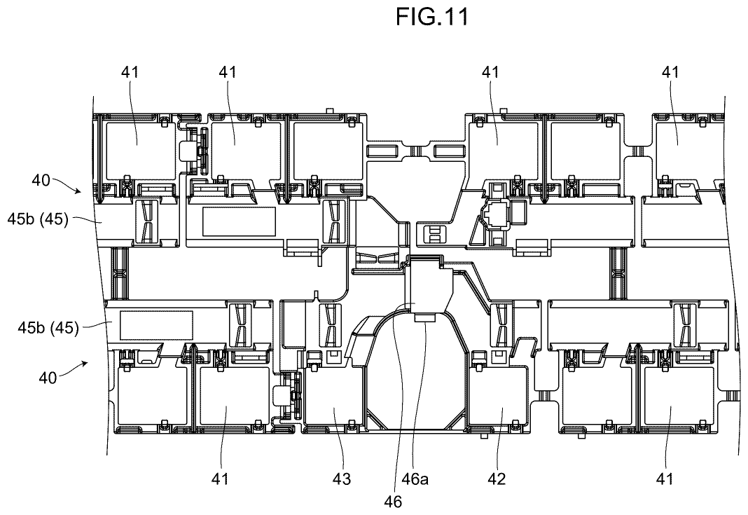

First, in the electric wire housing part 44, the electric wire 32 is routed in the arrangement direction of the battery cells BC along one wall surface 45a of the bottom wall 45 (FIG. 3, FIG. 8, and FIG. 9). For example, in each of the electric wires 30 with the terminals connected to the second bus bar 20 and the first bus bar 10 adjacent to the second bus bar 20, the electric wire 32 thereof is routed toward the first direction side, which is one side of the arrangement direction. Next, the bypass part 23 of the second bus bar 20 is disposed on another wall surface 45b side of the bottom wall 45 (FIG. 4, FIG. 10, and FIG. 11). Due to this, the bus bar module 1 can prevent interference between the bypass part 23 of the second bus bar 20 and the electric wire 32 in the electric wire housing part 44. In the electric wire housing part 44 described herein, the bypass part 23 is disposed along the other wall surface 45b of the bottom wall 45 at a portion bypassing the projection Bpro in a U-shape on the battery module BM. Due to this, in the bus bar module 1, the electric wire 30 can be routed without extending the routing path more than necessary on the one wall surface 45a side of the bottom wall 45 at the bypassing portion. The exemplified bus bar module 1 is assembled to the battery module BM in a state in which the other wall surface 45b of the bottom wall 45 is disposed to be opposed to the battery module BM.

The housing case 40 includes a cover part 46 that is disposed to be opposed to the other wall surface 45b of the bottom wall 45 at an interval, and houses the bypass part 23 between itself and the other wall surface 45b of the bottom wall 45 (FIG. 4, FIG. 10, and FIG. 11). The cover part 46 is coupled to the electric wire housing part 44 via a living hinge 46a serving as a rotating shaft. Thus, the cover part 46 can perform a rotating operation between a closed state of being opposed to the other wall surface 45b of the bottom wall 45 and an opened state of being not opposed to the other wall surface 45b.

Furthermore, the bus bar module 1 is configured as follows to prevent interference between the bypass part 23 of the second bus bar 20 and the electric wire connection part 31c of the terminal fitting 31 of the electric wire with the terminal 30, and prevent interference between the bypass part 23 and the electric wire 32 drawn out from the electric wire connection part 31c.

The housing case 40 includes a first electric wire lead-out path 47 that allows the electric wire 32 of the electric wire with the terminal 30 in which the terminal fitting 31 is physically and electrically connected to the first electrical connection part 21 of the second bus bar 20 to be drawn into the electric wire housing part 44 while being tilted toward the first direction side of the arrangement direction of the battery cells BC, and a second electric wire lead-out path 48 that allows the electric wire 32 of the electric wire with the terminal 30 in which the terminal fitting 31 is physically and electrically connected to the second electrical connection part 22 of the second bus bar 20 to be drawn into the electric wire housing part 44 while being tilted toward the first direction side of the arrangement direction of the battery cells BC (FIG. 3, FIG. 8, and FIG. 9).

Herein, in the terminal fitting 31, the electric wire connection part 31c is projected while being tilted as described below from a corner part on the electric wire housing part 44 side and on the first direction side of the terminal connection part 31a housed in the second bus bar housing part 42 on the same plane as the terminal connection part 31a. The electric wire connection part 31c is projected from the corner part while being tilted to the electric wire housing part 44 side and the first direction side. The electric wire connection part 31c is disposed on the first electric wire lead-out path 47, and allows the electric wire 32 to be drawn out toward the electric wire housing part 44 side and the first direction side in the first electric wire lead-out path 47. Thus, the first electric wire lead-out path 47 is coupled to the second bus bar housing part 42 on the first direction side with respect to a position of the center of gravity of the inside electrode terminal BC2 in the arrangement direction of the battery cells BC, and the bypass part 23 of the second bus bar 20 is projected to the outside from the second direction side with respect to the position of the center of gravity of the inside electrode terminal BC2 in the arrangement direction. In the second bus bar housing part 42 described herein, the first electric wire lead-out path 47 is coupled to an end part thereof on the first direction side, and the bypass part 23 of the second bus bar 20 is projected to the outside from an end part thereof on the second direction side. The bypass part 23 is disposed on the other wall surface 45b side of the bottom wall 45 of the electric wire housing part 44 at a position where the bypass part 23 is drawn out to the outside from the second bus bar housing part 42.

In the terminal fitting 31, the electric wire connection part 31c is projected while being tilted as follows from a corner part on the electric wire housing part 44 side and the first direction side of the terminal connection part 31a housed in the third bus bar housing part 43 on the same plane as the terminal connection part 31a. The electric wire connection part 31c is projected from the corner part while being tilted to the electric wire housing part 44 side and the first direction side. The electric wire connection part 31c is disposed on the second electric wire lead-out path 48, and allows the electric wire 32 to be drawn out toward the electric wire housing part 44 side and the first direction side in the second electric wire lead-out path 48. Thus, the second electric wire lead-out path 48 is coupled to the third bus bar housing part 43 on the first direction side with respect to the position of the center of gravity of the inside electrode terminal BC2 in the arrangement direction of the battery cells BC, and the bypass part 23 of the second bus bar 20 is projected to the outside from the second direction side with respect to the position of the center of gravity of the inside electrode terminal BC2 in the arrangement direction. In the third bus bar housing part 43 described herein, the second electric wire lead-out path 48 is coupled to an end part thereof on the first direction side, and the bypass part 23 of the second bus bar 20 is projected to the outside from an end part thereof on the second direction side. The bypass part 23 is disposed on the other wall surface 45b side of the bottom wall 45 of the electric wire housing part 44 at a position where the bypass part 23 is drawn out to the outside from the third bus bar housing part 43.

The second bus bar 20 is projected to the outside from the second direction side with respect to the position of the center of gravity of the electrode terminal BC2 in the arrangement direction of the battery cells BC from the second bus bar housing part 42 and the third bus bar housing part 43. Due to this, the second bus bar 20 is formed in an asymmetrical shape on the first direction as one side of the arrangement direction and the second direction side as the other side thereof.

In the bus bar module 1, interference between the bypass part 23 of the second bus bar 20 and the electric wire connection part 31c of the terminal fitting 31 of the electric wire with the terminal 30 can be prevented, and interference between the bypass part 23 and the electric wire 32 drawn out from the electric wire connection part 31c can be prevented due to such a shape of the second bus bar 20, positions of draw-out ports for the bypass part 23 of the second bus bar 20 in the second bus bar housing part 42 and the third bus bar housing part 43, a shape of the terminal fitting 31 of the electric wire with the terminal 30, arrangement of the first electric wire lead-out path 47 with respect to the second bus bar housing part 42, and arrangement of the second electric wire lead-out path 48 with respect to the third bus bar housing part 43.

The housing case 40 includes an electric wire lead-out path 49 that allows the electric wire 32 of the electric wire with the terminal 30 having the terminal fitting 31 physically and electrically connected to the first electrical connection part 11 or the second electrical connection part 12 of the first bus bar 10 to be drawn into the electric wire housing part 44 while being tilted to the first direction side or the second direction side of the arrangement direction of the battery cells BC (FIG. 3, FIG. 8, and FIG. 9).

The exemplified bus bar module 1 is assembled to the battery module BM in a state in which the other wall surface 45b of the bottom wall 45 of the electric wire housing part 44 is disposed to be opposed to the battery module BM. The embodiment is not limited thereto, and the bus bar module 1 may be assembled to the battery module BM in a state in which the one wall surface 45a of the bottom wall 45 of the electric wire housing part 44 is disposed to be opposed to the battery module BM.

The bus bar module 1 includes the bus bars (the first bus bar 10, the second bus bar 20) physically and electrically connected to the respective electrode terminals BC2 of the first electrode terminal group BC3, the electric wires 30 with the terminals physically and electrically connected to the respective bus bars (the first bus bar 10, the second bus bar 20) corresponding to the first electrode terminal group BC3, and the housing case 40 that houses the respective bus bars (the first bus bar 10, the second bus bar 20) corresponding to the first electrode terminal group BC3 and the respective electric wires 30 with the terminals. Furthermore, the bus bar module 1 includes the bus bars (the first bus bar 10) physically and electrically connected to the respective electrode terminals BC2 of the second electrode terminal group BC4, the electric wires 30 with the terminals physically and electrically connected to the respective bus bars (the first bus bar 10) corresponding to the second electrode terminal group BC4, and the housing case 40 that houses the respective bus bars (the first bus bar 10) corresponding to the second electrode terminal group BC4 and the respective electric wires 30 with the terminals. In the bus bar module 1 described herein, the housing case 40 on the first electrode terminal group BC3 side and the housing case 40 on the second electrode terminal group BC4 side are coupled to each other to configure one housing member. Thus, the bus bar module 1 described herein includes the housing member, the bus bars (the first bus bar 10, the second bus bar 20) on the first electrode terminal group BC3 side, the electric wires 30 with the terminals on the first electrode terminal group BC3 side, the bus bars (the first bus bars 10) on the second electrode terminal group BC4 side, and the electric wires 30 with the terminals on the second electrode terminal group BC4 side.

As described above, even in a case in which the projection Bpro is present between the electrode terminals BC2 of the battery module BM, the bus bar module 1 in the present embodiment can be assembled to the battery module BM by setting the second bus bar 20 avoiding the projection Bpro. On the other hand, in this bus bar module 1, the bypass part 23 of the second bus bar 20 is brought closer to the routing path of the electric wire 32 of the electric wire with the terminal 30 to avoid the projection Bpro. However, by routing the electric wire 32 on the one wall surface 45a side of the bottom wall 45 and arranging the bypass part 23 on the other wall surface 45b side of the bottom wall 45 across the bottom wall 45 of the electric wire housing part 44 for the electric wire 32, interference between the bypass part 23 and the electric wire 32 can be prevented. Thus, the bus bar module 1 in the present embodiment is preferable to bypass the projection Bpro.

In the bus bar module 1 in the present embodiment, in the second bus bar housing part 42, the first electric wire lead-out path 47 is coupled to the end part on the first direction side, and one end side of the bypass part 23 is projected from the end part on the second direction side to the outside. In the bus bar module 1, in the third bus bar housing part 43, the second electric wire lead-out path 48 is coupled to the end part on the first direction side, and the other end side of the bypass part 23 is projected from the end part on the second direction side to the outside. That is, regarding the electric wire with the terminal 30 in the second bus bar housing part 42, the electric wire connection part 31c of the terminal fitting 31 and the electric wire 32 drawn out from the electric wire connection part 31c pass through the first electric wire lead-out path 47, and the electric wire 32 is passed from the first electric wire lead-out path 47 to the electric wire housing part 44. Regarding the electric wire with the terminal 30 in the third bus bar housing part 43, the electric wire connection part 31c of the terminal fitting 31 and the electric wire 32 drawn out from the electric wire connection part 31c pass through the second electric wire lead-out path 48, and the electric wire 32 is passed from the second electric wire lead-out path 48 to the electric wire housing part 44. On the other hand, regarding the bypass part 23 of the second bus bar 20, one end side thereof is disposed at a position shifted from the first electric wire lead-out path 47, and the other end side thereof is disposed at a position shifted from the second electric wire lead-out path 48. Due to this, the bus bar module 1 can prevent interference between the bypass part 23 and the electric wire connection part 31c of the electric wire with the terminal 30, and can prevent interference between the bypass part 23 and the electric wire 32 of the electric wire with the terminal 30 drawn out from the electric wire connection part 31c. Thus, the bus bar module 1 in the present embodiment is preferable to bypass the projection Bpro.

In the bus bar module 1 in the present embodiment, the electric wire housing part 44 is disposed to be adjacent to the first bus bar housing part 41, the second bus bar housing part 42, and the third bus bar housing part 43 in the direction orthogonal to the arrangement direction of the battery cells BC and the direction orthogonal to the planes of the first electrical connection parts 11 and 21 and the second electrical connection parts 12 and 22, and the second bus bar 20 having a flat plate shape is used. In the bus bar module 1, the electric wire 32 is routed on the one wall surface 45a side of the bottom wall 45 of the electric wire housing part 44, and the bypass part 23 is disposed on the other wall surface 45b side of the bottom wall 45. Due to this, in the bus bar module 1 in the present embodiment, a height in the direction orthogonal to the planes of the first electrical connection parts 11 and 21 and the second electrical connection parts 12 and 22 can be suppressed to be low. Thus, the bus bar module 1 contributes to reduction of the height of the battery pack BP. Furthermore, in the bus bar module 1, the terminal connection part 31a having a flat plate shape is used for the terminal fitting 31 of the electric wire with the terminal 30, so that the height of the battery pack BP can be further reduced.

In the bus bar module 1 in the present embodiment, the second bus bar 20 can be caused to follow variation of the inter-electrode pitch by forming the bypass part 23 to be able to be distorted or deformed. In the bus bar module 1, as described above, the cross-sectional area of the first electrical connection part 21, the cross-sectional area of the second electrical connection part 22, and the cross-sectional area of the bypass part 23 are caused to have the same size to suppress differences in the electrical resistance value among the respective parts of the second bus bar 20, and the second bus bar 20 can be caused to follow variation of the inter-electrode pitch while suppressing lowering of energization performance of the second bus bar 20.

Even in a case in which a projection is present between electrode terminals of a battery module, the bus bar module according to the present embodiment can be assembled to the battery module by setting a second bus bar avoiding the projection. On the other hand, in this bus bar module, a bypass part of the second bus bar is brought closer to a routing path of an electric wire of an electric wire with a terminal to avoid the projection. By routing the electric wire on one wall surface side of a bottom wall and arranging the bypass part on another wall surface side of the bottom wall across the bottom wall of an electric wire housing part for the electric wire, interference between the bypass part and the electric wire can be prevented. Thus, the bus bar module according to the present embodiment is preferable to bypass the projection. In the bus bar module according to the present embodiment, in the second bus bar housing part, a first electric wire lead-out path is coupled to an end part on a first direction side, and one end side of the bypass part is projected from an end part on a second direction side to the outside. In this bus bar module, in a third bus bar housing part, a second electric wire lead-out path is coupled to an end part on the first direction side, and the other end side of the bypass part is projected from an end part on the second direction side to the outside. Regarding an electric wire with a terminal in the second bus bar housing part, the electric wire thereof is passed from the first electric wire lead-out path to the electric wire housing part. Regarding an electric wire with a terminal in the third bus bar housing part, the electric wire thereof is passed from the second electric wire lead-out path to the electric wire housing part. On the other hand, regarding the bypass part of the second bus bar, one end side thereof is disposed at a position shifted from the first electric wire lead-out path, and the other end side thereof is disposed at a position shifted from the second electric wire lead-out path. Due to this, this bus bar module can prevent interference between the bypass part and the electric wire of the electric wire with the terminal. Thus, the bus bar module according to the present embodiment is preferable to bypass the projection.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

1. A bus bar module comprising:
a bus bar that is a conductive member physically and electrically connected to each of electrode terminals of a plurality of battery cells arranged in a line in a battery module, and connects a pair of electrode terminals for each combination of the electrode terminals that are adjacent to each other with a space therebetween in an arrangement direction of the battery cells;
an electric wire with a terminal that includes a terminal fitting physically and electrically connected to the bus bar on one terminal of the electric wire, and electrically connects another terminal side of the electric wire to a battery monitoring unit that monitors a battery state of the battery cell; and
an insulating housing case that houses the bus bar and the electric wire with the terminal, wherein
a plurality of the bus bars are broadly divided into a first bus bar extended in the arrangement direction to connect the pair of electrode terminals, and a second bus bar that is caused to bypass a projection in the space included in the battery module in a U-shape on the battery module to connect the pair of electrode terminals while avoiding the projection,
the second bus bar includes a first electrical connection part having a flat plate shape that is physically and electrically connected to one of the pair of electrode terminals, a second electrical connection part having a flat plate shape that is physically and electrically connected to another of the pair of electrode terminals, and a U-shaped bypass part that connects the first electrical connection part with the second electrical connection part and bypasses the projection on the battery module,
the housing case includes a first bus bar housing part that houses the first bus bar, a second bus bar housing part that houses the first electrical connection part of the second bus bar, a third bus bar housing part that houses the second electrical connection part of the second bus bar, and an electric wire housing part that houses the electric wire and guides the electric wire toward the battery monitoring unit side along a bottom wall disposed to be opposed to the battery module,
the electric wire housing part is disposed to be adjacent to the first bus bar housing part, the second bus bar housing part, and the third bus bar housing part in a direction orthogonal to the arrangement direction and a direction orthogonal to planes of the first electrical connection part and the second electrical connection part, and is extended in the arrangement direction,
the electric wire is routed in the arrangement direction along one wall surface of the bottom wall, and
the second bus bar is disposed on another wall surface side of the bottom wall.

2. The bus bar module according to claim 1, wherein
the housing case includes a cover part that is disposed to be opposed to the other wall surface of the bottom wall at an interval, and houses the bypass part between the cover part and the other wall surface of the bottom wall.

3. The bus bar module according to claim 1, wherein
the second bus bar is formed in an asymmetrical shape on a first direction side as one side of the arrangement direction and a second direction side as the other side of the arrangement direction,
the housing case includes a first electric wire lead-out path that allows the electric wire of the electric wire with the terminal having the terminal fitting physically and electrically connected to the first electrical connection part to be drawn into the electric wire housing part while being tilted toward the first direction side of the arrangement direction, and a second electric wire lead-out path that allows the electric wire of the electric wire with the terminal having the terminal fitting physically and electrically connected to the second electrical connection part to be drawn into the electric wire housing part while being tilted toward the first direction side of the arrangement direction,
the first electric wire lead-out path is coupled to an end part on the first direction side of the second bus bar housing part, and the bypass part is projected from an end part on the second direction side to an outside, and
the second electric wire lead-out path is coupled to an end part on the first direction side of the third bus bar housing part, and the bypass part is projected from an end part on the second direction side to the outside.

4. The bus bar module according to claim 2, wherein
the second bus bar is formed in an asymmetrical shape on a first direction side as one side of the arrangement direction and a second direction side as the other side of the arrangement direction,
the housing case includes a first electric wire lead-out path that allows the electric wire of the electric wire with the terminal having the terminal fitting physically and electrically connected to the first electrical connection part to be drawn into the electric wire housing part while being tilted toward the first direction side of the arrangement direction, and a second electric wire lead-out path that allows the electric wire of the electric wire with the terminal having the terminal fitting physically and electrically connected to the second electrical connection part to be drawn into the electric wire housing part while being tilted toward the first direction side of the arrangement direction,
the first electric wire lead-out path is coupled to an end part on the first direction side of the second bus bar housing part, and the bypass part is projected from an end part on the second direction side to an outside, and
the second electric wire lead-out path is coupled to an end part on the first direction side of the third bus bar housing part, and the bypass part is projected from an end part on the second direction side to the outside.

5. A bus bar module comprising:
a bus bar that is a conductive member physically and electrically connected to each of electrode terminals of a plurality of battery cells arranged in a line in a battery module, and connects a pair of electrode terminals for each combination of the electrode terminals that are adjacent to each other with a space therebetween in an arrangement direction of the battery cells;
an electric wire with a terminal that includes a terminal fitting physically and electrically connected to the bus bar on one terminal of the electric wire, and electrically connects another terminal side of the electric wire to a battery monitoring unit that monitors a battery state of the battery cell; and
an insulating housing case that houses the bus bar and the electric wire with the terminal, wherein
a plurality of the bus bars are broadly divided into a first bus bar extended in the arrangement direction to connect the pair of electrode terminals, and a second bus bar that is caused to bypass a projection in the space included in the battery module in a U-shape on the battery module to connect the pair of electrode terminals while avoiding the projection,
the second bus bar includes a first electrical connection part having a flat plate shape that is physically and electrically connected to one of the pair of electrode terminals, a second electrical connection part having a flat plate shape that is physically and electrically connected to another of the pair of electrode terminals, and a U-shaped bypass part that connects the first electrical connection part with the second electrical connection part and bypasses the projection on the battery module, and the second bus bar is formed in an asymmetrical shape on a first direction side as one side of the arrangement direction and a second direction side as the other side of the arrangement direction,
the housing case includes a first bus bar housing part that houses the first bus bar, a second bus bar housing part that houses the first electrical connection part of the second bus bar, a third bus bar housing part that houses the second electrical connection part of the second bus bar, an electric wire housing part that houses the electric wire and guides the electric wire toward the battery monitoring unit side along a bottom wall disposed to be opposed to the battery module, a first electric wire lead-out path that allows the electric wire of the electric wire with the terminal having the terminal fitting physically and electrically connected to the first electrical connection part to be drawn into the electric wire housing part while being tilted toward the first direction side of the arrangement direction, and a second electric wire lead-out path that allows the electric wire of the electric wire with the terminal having the terminal fitting physically and electrically connected to the second electrical connection part to be drawn into the electric wire housing part while being tilted toward the first direction side of the arrangement direction,
the electric wire housing part is disposed to be adjacent to the first bus bar housing part, the second bus bar housing part, and the third bus bar housing part in a direction orthogonal to the arrangement direction and a direction orthogonal to a plane of the second bus bar, and is extended in the arrangement direction,
the first electric wire lead-out path is coupled to an end part on the first direction side of the second bus bar housing part, and the bypass part is projected from an end part on the second direction side to the outside, and
the second electric wire lead-out path is coupled to an end part on the first direction side of the third bus bar housing part, and the bypass part is projected from an end part on the second direction side to the outside.

6. The bus bar module according to claim 5, wherein
the terminal fitting includes a terminal connection part having a flat plate shape that is able to be arranged to be stacked on the first electrical connection part or the second electrical connection part, and is fastened together with the first electrical connection part or the second electrical connection part by a female screw member screwed on the electrode terminal having a male screw part.

7. The bus bar module according to claim 1, wherein
the second bus bar is formed in a flat plate shape having the first electrical connection part, the second electrical connection part, and the bypass part on a same plane,
the first electrical connection part and the second electrical connection part have a same plate thickness and a same interval between opposite sides in a direction orthogonal to the arrangement direction and a direction orthogonal to a plane of the second bus bar, and are formed in a rectangular flat plate shape having a same cross-sectional area of a cross section orthogonal to the arrangement direction, and
the bypass part is formed in a flat plate shape by making a plate width in a direction orthogonal to a center axis on a bypass route connecting the first electrical connection part with the second electrical connection part narrower than the interval between the opposite sides of the first electrical connection part and the second electrical connection part, making a plate thickness thicker than the plate thickness of the first electrical connection part and the second electrical connection part, and causing a cross-sectional area of a cross section orthogonal to the center axis to have a same size as the cross-sectional areas of the first electrical connection part and the second electrical connection part.

8. The bus bar module according to claim 2, wherein
the second bus bar is formed in a flat plate shape having the first electrical connection part, the second electrical connection part, and the bypass part on a same plane,
the first electrical connection part and the second electrical connection part have a same plate thickness and a same interval between opposite sides in a direction orthogonal to the arrangement direction and a direction orthogonal to a plane of the second bus bar, and are formed in a rectangular flat plate shape having a same cross-sectional area of a cross section orthogonal to the arrangement direction, and
the bypass part is formed in a flat plate shape by making a plate width in a direction orthogonal to a center axis on a bypass route connecting the first electrical connection part with the second electrical connection part narrower than the interval between the opposite sides of the first electrical connection part and the second electrical connection part, making a plate thickness thicker than the plate thickness of the first electrical connection part and the second electrical connection part, and causing a cross-sectional area of a cross section orthogonal to the center axis to have a same size as the cross-sectional areas of the first electrical connection part and the second electrical connection part.

9. The bus bar module according to claim 5, wherein
the second bus bar is formed in a flat plate shape having the first electrical connection part, the second electrical connection part, and the bypass part on a same plane,
the first electrical connection part and the second electrical connection part have a same plate thickness and a same interval between opposite sides in a direction orthogonal to the arrangement direction and a direction orthogonal to a plane of the second bus bar, and are formed in a rectangular flat plate shape having a same cross-sectional area of a cross section orthogonal to the arrangement direction, and
the bypass part is formed in a flat plate shape by making a plate width in a direction orthogonal to a center axis on a bypass route connecting the first electrical connection part with the second electrical connection part narrower than the interval between the opposite sides of the first electrical connection part and the second electrical connection part, making a plate thickness thicker than the plate thickness of the first electrical connection part and the second electrical connection part, and causing a cross-sectional area of a cross section orthogonal to the center axis to have a same size as the cross-sectional areas of the first electrical connection part and the second electrical connection part.

10. The bus bar module according to claim 7, wherein
the first bus bar is formed in a plate shape having a plate width in a direction orthogonal to the arrangement direction, and
each of the cross-sectional areas of the first electrical connection part, the second electrical connection part, and the bypass part is caused to be a same size as a cross-sectional area of a cross section orthogonal to the arrangement direction of the first bus bar.

11. The bus bar module according to claim 8, wherein
the first bus bar is formed in a plate shape having a plate width in a direction orthogonal to the arrangement direction, and
each of the cross-sectional areas of the first electrical connection part, the second electrical connection part, and the bypass part is caused to be a same size as a cross-sectional area of a cross section orthogonal to the arrangement direction of the first bus bar.

12. The bus bar module according to claim 9, wherein
the first bus bar is formed in a plate shape having a plate width in a direction orthogonal to the arrangement direction, and
each of the cross-sectional areas of the first electrical connection part, the second electrical connection part, and the bypass part is caused to be a same size as a cross-sectional area of a cross section orthogonal to the arrangement direction of the first bus bar.
